(19) United States
(12) Patent Application Publication
(10) Pub. No.: US 2005/0194216 A1
(43) Pub. Date: Sep. 8, 2005

(54) Self-lubricating device for use in an optical instrument

(75) Inventor: Yung-Lung Lin, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/062,444

(22) Filed: Feb. 22, 2005

(30) Foreign Application Priority Data
Mar. 3, 2004 (TW) 93105568

(51) Int. Cl. F16N 1/00

(52) U.S. Cl. 184/5

(57) ABSTRACT

A self-lubricating device for supplying lubricant onto a threaded guide rod, includes a movable member disposed above the threaded guide rod, and has lower threads meshed with the threaded guide rod, and a lubricant supplier secured on the movable member, and has a nozzle extending into the movable member for supply of lubricant onto the threaded guide rod. The movable member is movable axially on the threaded guide rod in such a manner to rotate the latter upon actuated.

### FIELD OF THE INVENTION

The present invention relates to a self-lubricating device, more particularly to a self-lubricating device for use in an optical instrument, such as a disk drive.

### BACKGROUND OF THE INVENTION

The rapid advent of electronic technology brings lots of improvement to the external peripheral devices, such as a disk drive, an optical recording and reproducing instrument (DVD player), an image scanner, and a printing machine are the most common external peripheral devices and they are generally used together with the personal computer so as to provide an outmost performance. The wide use of personal computers consequently results in fast development of the external peripheral devices, since the utility of the former is not complete without the latter. In other words, after a document is written in the personal computer, a printing machine is required to print out the document. A DVD (digital versatile disc) of the latest development has 17 GB storage capacity, possesses high transmission characteristics, and causes wide utility of the DVD player by the consumers.

FIG. 1 shows a fragmentary view of a conventional optical instrument, such as a disk drive, which includes a spindle motor 100 for rotating an optical disk (not shown), a reading mechanism 200, and a lubricant supplier 300. The reading mechanism 200 includes a pick-up head 260 that is disposed at an elevation above a disk-receiving tray (not shown) and that has one side 281 retained slidably in a guiding groove 220 of a mounting frame. A rack 282 is formed at the other side 280 of the pick-up head 260, meshes with a threaded guide rod 240 (see FIGS. 2A and 2B), which, in turn, is journalled on a mounting base 320. The threaded guide rod 240 has one output end connected co-axially to a motor 340 such that the threaded guide rod 240 rotates about its axis upon actuation of the motor 340, thereby driving the pick-up head 260 to move axially of the threaded guide rod 240 to conduct reading operation of the optical disk disposed underneath. The lubricant supplier 300 includes a lubricant container 360 disposed above the threaded guide rod 240 (see FIG. 3) for supplying lubricant in order to reduce noise and smooth movement of the pick-up head 260 on the threaded guide rod 240.

Manually moving the lubricant container 360 along upward-and-downward direction and left-and-right direction is inconvenient and laborious for the user. In addition, the motor 340 must be actuated so as to rotate the threaded guide rod 240 in order to apply the lubricant uniformly along the entire length of the threaded guide rod 240.

### SUMMARY OF THE INVENTION

The object of the present invention is to provide a self-lubricating device for supplying lubricant onto a threaded guide rod which is use in the optical instrument for driving a pick-up head.

According to the present invention, a self-lubricating device for supplying lubricant onto a threaded guide rod is proposed and includes: a movable member adapted to be disposed above the threaded guide rod, and having lower threads adapted be meshed with the threaded guide rod; and a lubricant supplier secured on the movable member, and having a nozzle extending into the movable member for supply of lubricant onto the threaded guide rod, wherein the movable member is movable axially on the threaded guide rod in such a manner to rotate the latter upon actuated.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is a perspective fragmentary view of a conventional optical instrument, illustrating how a pick-up head for reading an optical disk is actuated by a threaded guide rod;

FIG. 2A is a lateral view of the conventional optical instrument, illustrating how the pick-up head for reading the optical disk is actuated by the threaded guide rod;

FIG. 2B is a side view of the conventional optical instrument, illustrating how the pick-up head for reading the optical disk is actuated by the threaded guide rod;

FIG. 3 illustrates how the threaded guide rod of the conventional optical instrument is lubricated;

FIG. 4 is a schematic view of the preferred embodiment of a self-lubricating device of the present invention for use in an optical instrument;

FIG. 5 is an enlarged perspective view of a movable member employed in the preferred embodiment of the self-lubricating device of the present invention for use in the optical instrument;

FIG. 6A is an enlarged perspective view of a modified movable member employed in the preferred embodiment of the self-lubricating device of the present invention for use in the optical instrument; and

FIG. 6B illustrates how the modified movable member is mounted on a threaded guide rod of the preferred embodiment of the present invention for use in the optical instrument.

### DETAILED DESCRIPTION OF THE PREFERRED EMBODIMENT

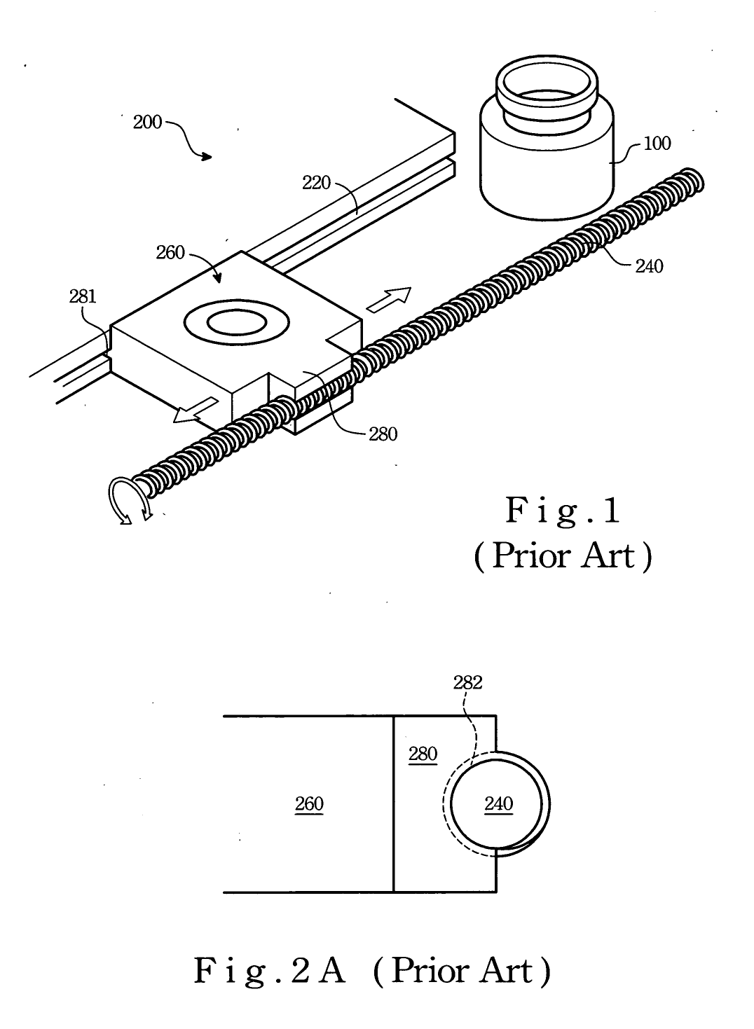

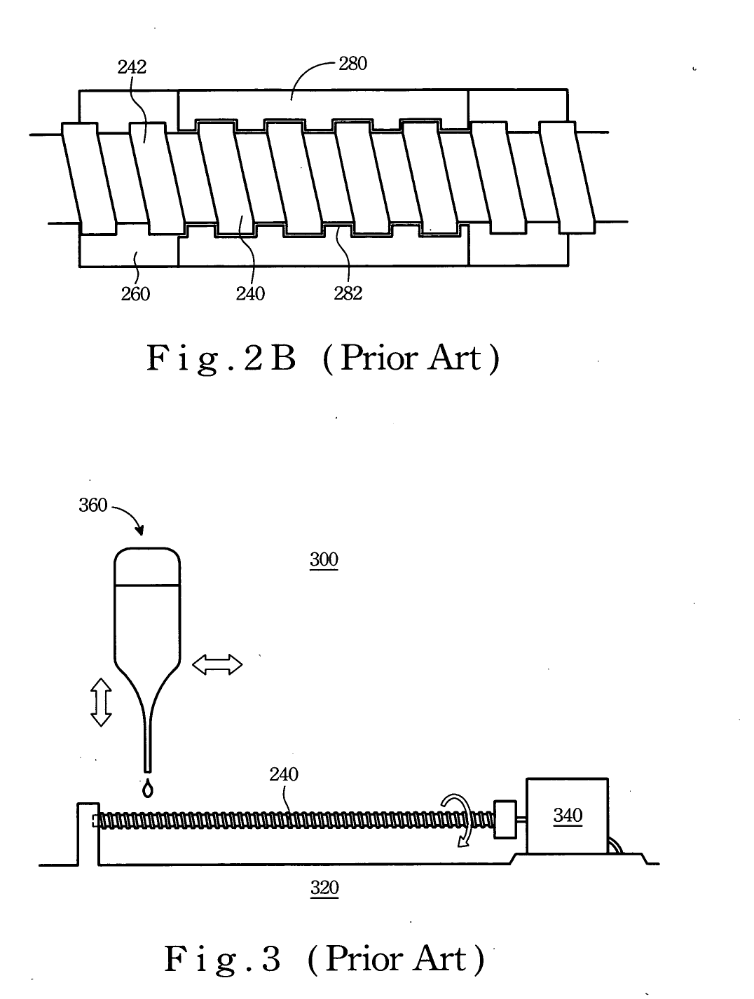

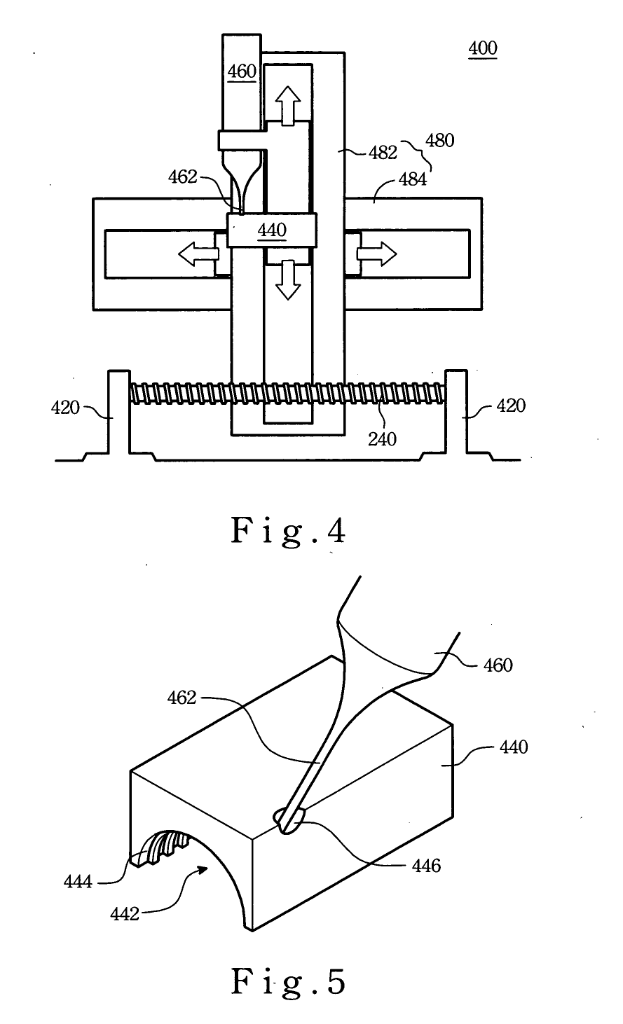

Referring to FIG. 4, the preferred embodiment of a self-lubricating device 400 according to the present invention is used in an optical instrument, such as a disk drive, which includes a threaded guide rod 240 for driving the pick-up head (see FIG. 1) for reading an optical disk. The self-lubricating device 400 includes a movable member 440, a lubricant supplier 460, a mounting seat 420, and an actuating member 480.

As illustrated, the movable member 440 is disposed above the threaded guide rod 240, and has lower threads 444 meshed with the threaded guide rod 240.

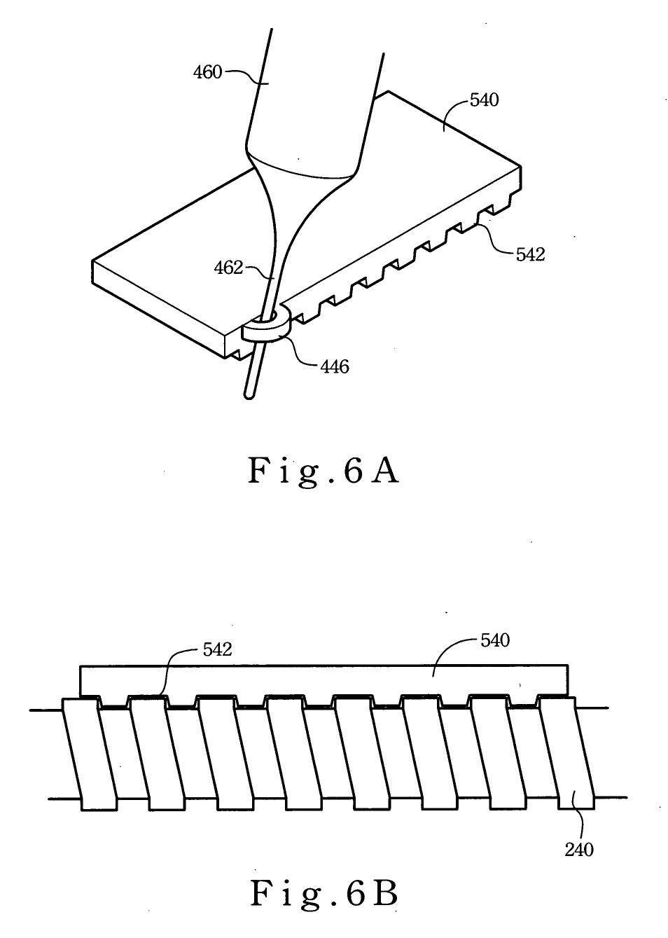

The lubricant supplier 460 (see FIGS. 5 and 6) is secured on the movable member 440, and includes a lubricant container having a nozzle 462 extending into the movable member 440 in such a manner for supply of lubricant onto the threaded guide rod 240. The movable member 440 is movable axially on the threaded guide rod 240 in such a manner to rotate the latter upon actuated.

In this preferred embodiment, the threaded guide rod 240 has two opposite ends connected to two spaced apart lugs of the mounting seat 420.

The actuating member 480 is disposed above the movable member 440, and includes a first actuating piece 482 providing a downwardly biasing action onto the movable member 440 for meshing with the threaded guide rod 240, and a second actuating piece 484 for reciprocally moving the movable member 440 axially of the threaded guide rod 240, thereby rotating the threaded guide rod 240 about its axis. The driving means, such as high compressed pressure or hydraulic means, is used for driving the movable member 440. Preferably, the movable member 440 is formed with a retention ring 446 for retaining the nozzle 462 of the lubricant supplier 460.

Referring to FIG. 5, the movable member 440 is block-shaped, and has an inwardly concave bottom surface 442 formed with serrated portions defining the lower threads 444 (see FIG. 5).

Referring to FIGS. 6A, and 6B, alternatively, the movable member 540 is block-shaped, and has a flat bottom surface formed with serrated portions 542 defining the lower threads 444 and meshed with the threaded guide rod 240.

Since application of lubricant onto the threaded guide rod 240 is automatically conducted and since no motor is used for driving the movable member 440 of the self-lubricating device of the present invention, the prior art disadvantages thereof are accordingly avoided.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

1. A self-lubricating device for supplying lubricant onto a threaded guide rod, comprising:
a movable member adapted to be disposed above the threaded guide rod, and having lower threads adapted be meshed with the threaded guide rod; and
a lubricant supplier attached to said movable member, and having a nozzle extending into the movable member for supply of lubricant onto the threaded guide rod, wherein said movable member is movable axially on the threaded guide rod in such a manner to rotate the threaded guide rod upon actuated.

2. The self-lubricating device according to claim 1, further comprising a mounting seat having a pair of spaced apart lugs, the threaded guide rod having two opposite ends connected to said lugs of said mounting seat.

3. The self-lubricating device according to claim 2, further comprising an actuating member that is disposed above said movable member and that includes a first actuating piece providing a downwardly biasing action onto said movable member for meshing with the threaded guide rod and a second actuating piece for reciprocally moving said movable member axially of the threaded guide rod, thereby rotating the threaded guide rod about its axis.

4. The self-lubricating device according to claim 3, wherein said movable member is disposed with a retention ring for retaining said nozzle of said lubricant supplier.

5. The self-lubricating device according to claim 4, wherein said movable member is block-shaped, and has an inwardly concave bottom surface formed with serrated portions defining said lower threads.

6. The self-lubricating device according to claim 4, wherein said movable member is block-shaped, and has a bottom surface formed with serrated portions defining said lower threads.

7. A method for supplying lubricant onto a threaded guide rod by means of a self-lubricating device that includes a movable member having lower threads and a lubricant supplier having a nozzle, the method comprising the steps of:
(i) disposing the movable member above the threaded guide rod in such a manner to mesh the lower threads of the movable member with the threaded guide rod;
(ii) securing the lubricant supplier on the movable member in such a manner that the nozzle extends into the movable member for supply of lubricant onto the threaded guide rod; and
(iii) actuating the movable member to move reciprocally and axially on the threaded guide rod in such a manner to result in rotation of the threaded guide rod about its axis.
